(19) United States
(12) Patent Application Publication
(10) Pub. No.: US 2001/0050988 A1
(43) Pub. Date: Dec. 13, 2001

(54) DISPLAY ASSEMBLY FOR A COMMUNICATION UNIT

(76) Inventor: BENT OLE POULSEN, OLSTYKKE (DK)

Correspondence Address: PERMAN &GREEN, 425 POST ROAD, FAIRFIELD, CT, 06430

(21) Appl. No.: 09/261,605

(22) Filed: Feb. 26, 1999

(30) Foreign Application Priority Data
Feb. 27, 1998 (GB) 9804278.1

(51) Int. Cl. H04M 1/00; G09G 3/00

(52) U.S. Cl. 379/433.04

(57) ABSTRACT

A display assembly for a communication unit is pre-assembled and handled as a single item in the later assembling of the communication unit. The display assembly comprises a protection window, a display module including a display screen, and a back lighting means including a plate-shaped, light-guiding member for back lighting said display screen. Furthermore, coupling means is used for maintaining said display module sandwiched between said protection window and said back lighting means.

A dust seal is provided between the protection window and the display unit along the periphery of the display screen, whereby the pre-assembling may be performed under dustless conditions.

### BACKGROUND OF THE INVENTION

The invention relates to a display assembly for a communication unit, such as a cellular phone. When the display assembly includes a liquid crystal display (LCD), the display screen is back lighted to obtain a good contrast in the display. In general, the LCD is connected to the printed circuit board PCB of the unit via a flex print or a connector. However, the liquid crystals are provided on glass, and the display is therefore quite fragile.

In order to protect the LCD some phones are formed foldable with the LCD protected in folded position, and other phones are provided with a separate protection window aligned with and at a distance from the LCD. The protection window is fixed to the front cover of the phone prior to the assembling of the phone. The front cover may be received and handled as a unit from a subsupplier.

This causes problems of dust between the protection window and the LCD. The production line has to be very clean to avoid this dust problem. Furthermore the pre-assembling of the front cover/protection window has to be handled under dustless conditions, too, to avoid dust on the pre-assembled items. The transport from the pre-assembling line to the production line has to be done under dustless conditions, too.

The invention method is based on pre-assembling a display assembly for a communication unit and comprises the steps of sandwiching a display module including a display screen between a protection window and a plate-shaped, light-guiding member for back lighting said display screen, whereby a dustless cavity is created between the display screen and the protection window, and locking said sandwich structure together by coupling means to a self-carrying structure. Preferably, the locking is provided by snap coupling. Hereby, the display assembly may be assembled in advance under dustless conditions, e.g. by a subsupplier, and handled as a single item during the assembling of the communication unit.

The invention furthermore relates to a display assembly for a communication unit, said display assembly comprising a protection window, a display module including a display screen, a back lighting means including a plate-shaped, light-guiding member for back lighting said display screen, and coupling means for maintaining said display module sandwiched between said protection window and said back lighting means, whereby a dustless cavity is created between the display screen and the protection window. The display assembly, when assembled, may be transported under the same conditions as all other pre-assemblies, e.g. buzzers, batteries, microphones, of communication units, such as e.g. hand portable phones.

The invention provides a new and improved method according to which a display assembly for a communication unit may be assembled without any problems of dust between the display screen and the protection window.

The invention also provides a display assembly that is easy to handle during the assembling of the communication unit.

The invention also provides a display assembly having a robust interface to the rest of the communication unit.

### SUMMARY OF THE INVENTION

According to a preferred embodiment of the display assembly according to the invention the light sources for back lighting the display screen are integrated in the assembly. A number of light emitting diodes (LED) is mounted on a printed circuit board connected to the display module offset from the display screen. Depressions or holes in the plate-shaped, light-guiding member are provided for receiving said diodes at least partially. The coupling of light into the light guide is hereby independent of the relative position between the display assembly and the printed circuit board of the communication unit. The complexity of the mechanical interface between these two parts is reduced.

The protection window is provided with a slight dome shape to increase its strength and to create a cavity between the rear side of the window and the front side of the display screen. For example for a phone the display is not protected by a cover when the phone is not in use. The resilient properties of the protection window ensure that the display screen will not be crashed in normal handling. By providing a resilient dust seal between the protection window and the display unit along the periphery of the display screen it is ensured that the display screen will not be crashed even when subjected to rough handling. At the same time the cavity inside the assembly will be dustproof.

Preferably, the coupling means are provided on the plate-shaped, light-guiding member and the protection window as a number of plastics lugs and tabs for mutual engagement. These lugs may be in the form of gripping walls extending substantially perpendicularly to the plane of the display screen along two opposite sides of the light-guiding member. When the gripping walls are provided with recesses for receiving corresponding tabs of the protection window, unintended disassembling in the stacking direction is avoided. Unintended torsion of the parts is prevented by the reception of the tabs in the recesses.

Due to the resilient properties of the parts when provided by injection molding the gripping walls will establish a snap connection with the tabs according to the preferred embodiment. By extending the gripping wails on both sides of the plate-shaped, light-guiding member the snap connection may be temporarily locked by preventing movement of the gripping wall parts facing away from the protection window. By using these gripping wall parts facing away from the protection window as guide tracks for a printed circuit board received between the walls after the assembly of the phone, the protection window will be retained securely during normal use of the phone.

The rear side of the plate-shaped, light-guiding member is coated with a reflecting layer which prevents light from escaping via the rear side of the assembly.

The printed circuit board carrying the light emitting diodes is provided along one side of the display screen on the display unit, and, according to the preferred embodiment, said printed circuit board also carries the display driver and a multi-pin connector part for establishing electrical connections with a communication unit in which the assembly is used. The plate-shaped, light-guiding member is extended with a carrier part supporting said display driver carrying said printed circuit board. This carrier part is provided with aligning means and fastening means for aligning and fastening the assembly in relation to the communication unit in which the assembly is used.

### BRIEF DESCRIPTION OF THE DRAWINGS

FIG. 1 is a perspective view of a preferred embodiment of the communication unit according to the invention.

FIG. 2 is an exploded view of the essential parts of the communication unit shown in FIG. 1.

FIG. 3 is a view of a preferred embodiment of a pre-assembled display assembly according to the invention.

FIG. 4 is an exploded view of the pre-assembled display assembly shown in FIG. 3.

FIG. 5 is a partially cross-sectional view on an enlarged scale of a part of the pre-assembled display assembly shown in FIG. 3.

### DETAILED DESCRIPTION

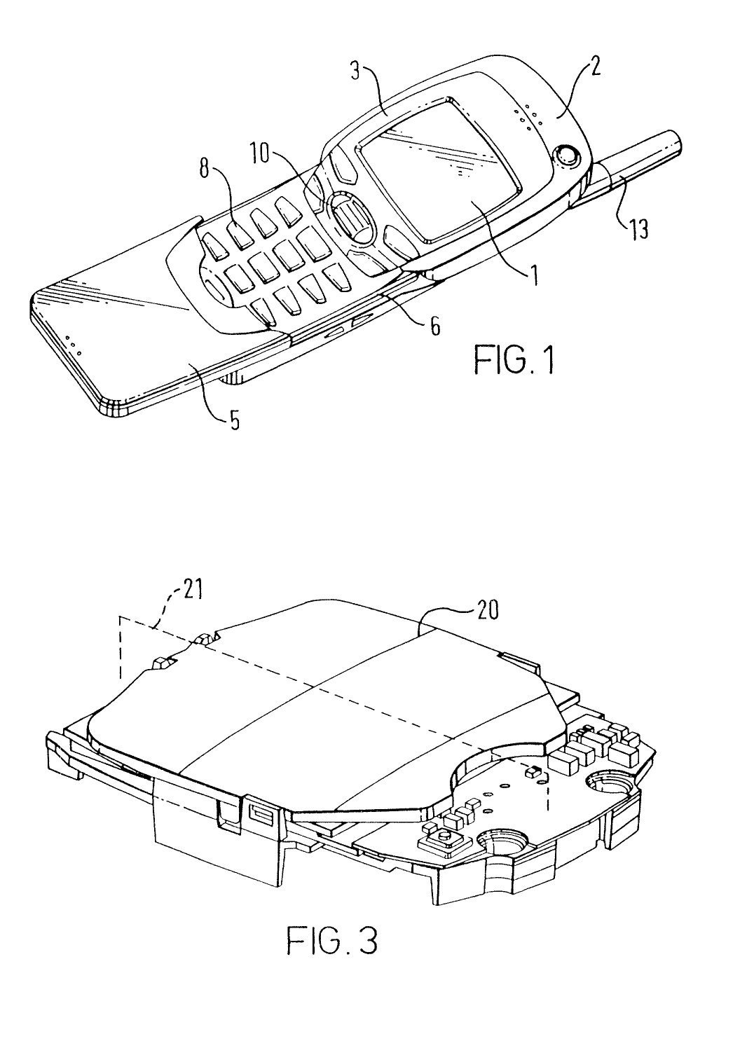

According to a first aspect of the invention the pre-assembled display assembly is integrated into a hard portable phone, e.g. a cellular phone. A preferred embodiment of this phone is shown in FIG. 1. As will be seen, the phone is provided with front cover 2 having a window frame 3 encircling the protection window of the display assembly 1. The front cover 2 is formed by injection molding in polycarbonate (PC), acrylonitrile butadiene styrene (ABS) or other robust plastics. The window frame 3 is formed by injection molding in e.g. ABS and then metalized. It will furthermore be seen how the phone is provided with a slide cover 5 snapped onto a metal slide frame 6 sliding in slide tracks 7 in the front cover 2 along a keypad area and in extension thereof

The front cover 2 is provided with a plurality of openings, the largest one being an opening 4 in which the protection window 14 of the display assembly 1 is received. In the keypad area the front cover 2 is provided with sixteen openings through which the keys of a keypad 8 extend. A navigation key assembly 10 extends partly through the front cover 2 between the other keys and the display.

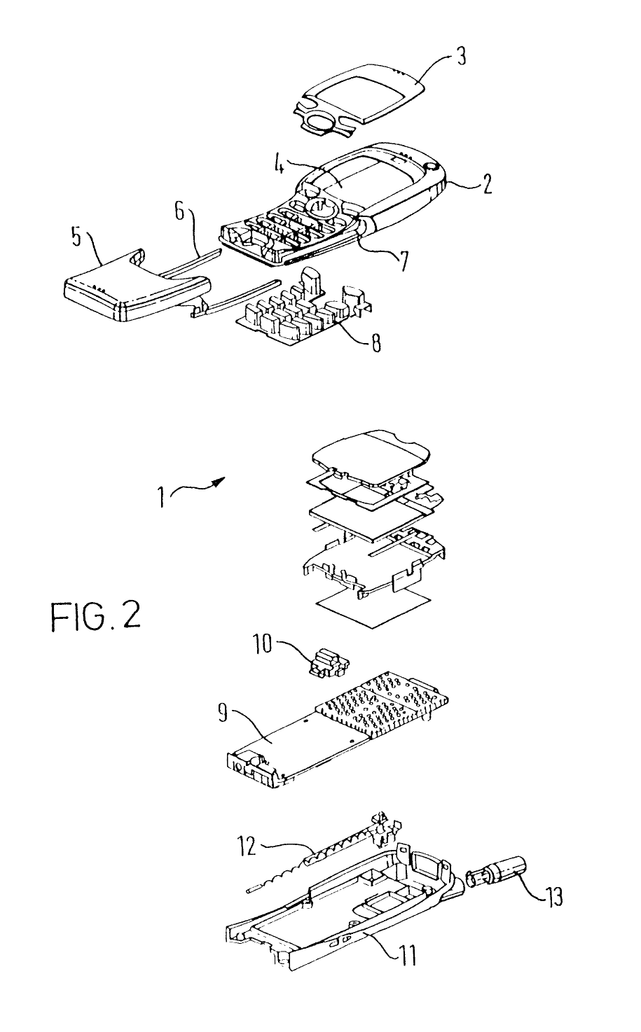

As will be seen from FIG. 2, the keypad 8, the navigation key assembly 10 and the display assembly 1 rest on and are electrically connected to a printed circuit board (PCB) 9 of the phone.

An antenna 13 is mounted in the top corner of a back cover 11 and is connected to the RF circuit on the PCB 9. A spring based/latch based slide release mechanism 12 is included along one of the side walls of the back cover 11. One end of the slide release mechanism 12 is fixed to the metal slide frame 6. When the latch mechanism (not shown) is released, the spring of the slide release mechanism forces the slide to open in a soft movement.

The display assembly 1 according to the invention will be explained in detail in the following with reference to FIGS. 3-5. The protection window 14 is injection molded in a clear and mechanically resistant plastics material, such as clear polymethyl methacrylate (PMMA). The protection window 14 covers and protects a display screen, e.g. an LCD display 17, provided on a display module 16. A dust seal 15 of punched foam provided with an appropriate adhesive is inserted along the edge of the LCD display 17 between the display module 16 and the window 14.

As will be seen from two virtual lines 20 and 21 in FIG. 3—the first one follows the curvature of the window and the second one is straight—the protection window 14 is provided with a slight dome shape to increase its strength and to create a cavity between the window 14 and the LCD display 17. The resilient properties of the window 14 will protect the LCD display 17, and the presence of the foamed dust seal 15 (works as a shock absorber) will increase this protection significantly.

In addition, the dust seal 15 effectively maintains a dustless cavity between the window 14 and the display module 17 once the pre-assembling has been performed under dustless conditions. The LCD display 17 is provided on a glass plate 21 (support for the display 17) as a liquid crystal structure know per se and having connectors arranged in a matrix configuration. In addition to the glass plate 21 and the display 17, the display module 16 comprises a small PCB 20 carrying a multi-pin connector part 22 for connecting the display assembly 1 with a corresponding connector part on the PCB 9. By providing the connectors in the connector part 22 as a microball grid array with resilient pins the connectors in the corresponding connector part on the PCB 9 may be metallic pads.

In addition to the connector 22, the small PCB 20 carries some components for an LCD driver circuit Oust schematically illustrated) and four light emitting diodes (LED) 23 (shown schematically in FIG. 5). These circuits will be trivial to a person skilled in the art.

The back side of the fragile glass plate 21 is supported by a plate-shaped, light-guiding member 18 provided by injection molding in a clear light-guiding plastics material e.g. PC (polycarbonate) or PMMA. The plate-shaped, light-guiding member 18 is extended with a carrier part 24 which supports the PCB 20. The carrier part 24 is provided with a channel 25 in which the connector part 22 is received. The carrier part 24 rests on the PCB 9, and the length of the channel 25 ensures a well-defined pressure which acts on the connector pins. When the connector part 22 fits into the channel 25, a transversal displacement of the connector pins is avoided as the position of the carrier part 24 relatively to the PCB 9 is controlled.

The carrier part 24 is furthermore provided with cavities 26 or holes to receive the LED's 23 on the PCB 20. When the LED's 23 emit light in the direction of the arrow (FIG. 5), the light enters the light-guiding member 18 for illuminating or back lighting the display screen 17. A reflector 19 is adhered to the back side of the light-guiding member to reduce loss of light. The carrier part 24 is provided with tabs 27 interacting with corresponding holes 28 in the PCB 20. This reduces the risk of damage to the connector 22 if the phone is dropped.

On each side of the channel 25 the carrier part 24 is provided with two bushings 29 having substantially the same length as the channel 25. During the assembling the display assembly 1 is placed in a front cover 2 positioned with its face downwards. The keypad 8 and the navigation key 10 have already been placed in the front cover 2. Then the PCB 9 is placed on the top of the assembled parts. Screws (not shown) are passed through holes in the PCB 9 and the bushing 29 into screw towers (not shown) in the rear side of the front cover 2. Hereby the pre-assembled display assembly will be fixed to the front cover 2 and the PCB 9. After this the back cover 11 including the antenna 13 is placed on the PCB 9, and the front cover and the back cover are fixed to each other by means of screws (not shown).

According to the preferred embodiment, the coupling means for maintaining the display module 16 sandwiched between the protection window 14 and the light-guiding member 18 of the back lighting means are mainly provided along the edge of the light-guiding member 18.

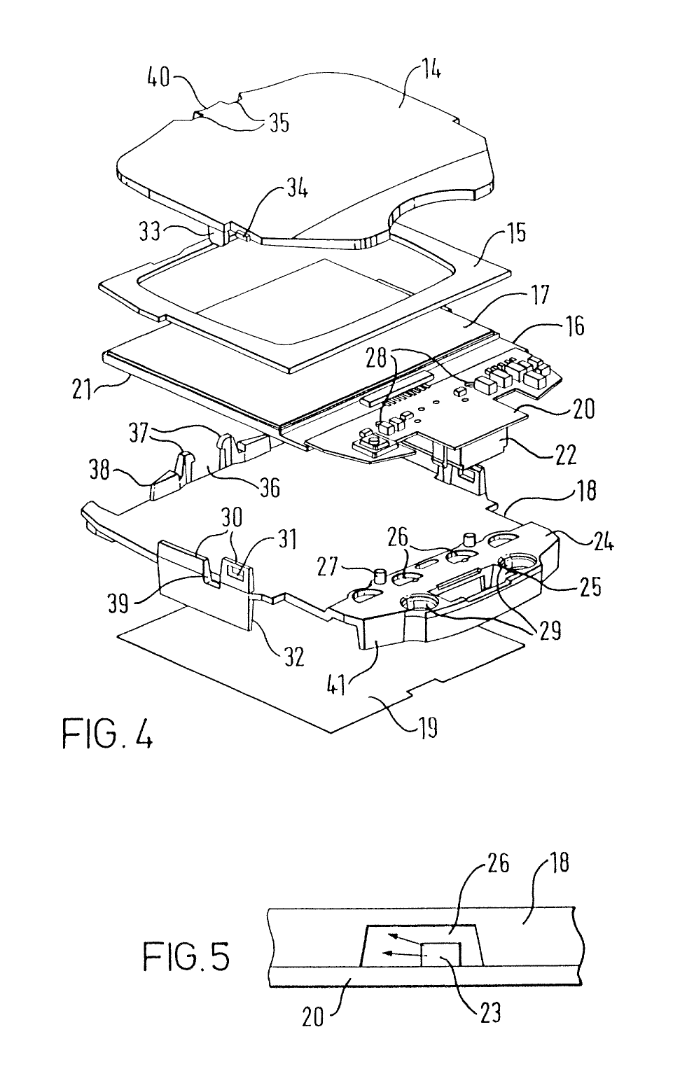

It will be seen from FIG. 4 how the light-guiding member 18 is provided with two wall parts 30 along the two sides in parallel with the longitudinal axis of the phone. The wall parts 30 extend in the building direction of the display assembly 1 and are divided by a cut 39. One of the wall parts 30 is formed with an eye 31, whereby a resilient lug for a snap connection is provided. The height of the wall parts 30 corresponds to the overall thickness of the display assembly 1, whereby the top of the wall parts 30 are aligned with the protection window 14. The protection window 14 has tabs 34 fitting into the eyes 31. The wall parts 30 provided with eyes 31 and the tabs 34 provide a snap connection based coupling means for locking the sandwich structure together to a self-carrying structure.

Another tab 33 is received in the cut 39 between the wall parts 30, whereby torsion between the protection window and the light-guiding member 18 is avoided. The protection window 14 is provided with two cuts 35 defining a tab 40 which, during the assembling of the display assembly 1, is received and fixed in a recess 36 between two hooks 37. Two stops 38 act as supports for the protection window 14.

The wall parts 30 extend in downwardly directed wall parts 32 which straddle the PCB 9. Via the wall parts 32 the display assembly rests against the back cover 11. When a force is applied to the protection window 14, the wall parts 30, 32 of the light-guiding member transfer the force directly to the back cover 11 of the phone. This prevents a force acting on the protection window 14 from being transferred to the PCB 9.

In view of the foregoing description it will be evident to a person skilled in the art that various modifications may be made within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during prosecution of this application or any such further application derived therefrom.

What is claimed is:

1. A method of pre-assembling a display assembly for a communication unit, comprising the steps of sandwiching a display module including a display screen between a protection window and a plate-shaped, light-guiding member for back lighting said display screen, whereby a dustless cavity is created between the display screen and the protection window; and locking said sandwich structure together by coupling means to a self-carrying structure.

2. A method according to claim 1, wherein the locking is provided by snap coupling the sandwich structure together.

3. A method of manufacturing a communication unit, using a display assembly assembled according to claim 1 and comprising the steps of:
feeding a pre-assembled display assembly as an individual item to an assembly line;
placing the display assembly inside a first cover part of the communication unit and establishing an electrical connection to a circuit board of the communication unit;
placing a second cover part of the communication unit for enclosing the display assembly in such a way that the protection window is received in an opening of one of said cover parts through which the display screen is visible.

4. A display assembly for a communication unit to be handled as a single item upon assembling the communication unit, said display assembly comprising:
a protection window;
a display module including a display screen; and
a back lighting means including a plate-shaped, light-guiding member for back lighting said display screen; and
coupling means for maintaining said display module sandwiched between said protection window and said back lighting means, whereby a dustless cavity is created between the display screen and the protection window

5. A display assembly according to claim 4, wherein the back lighting means comprises a number of light emitting diodes (LED) mounted on a printed circuit board connected to the display module offset from the display screen and depressions or holes in the plate-shaped, light-guiding member for receiving said diodes at least partially.

6. A display assembly according to claim 4, wherein the protection window is provided with a slight dome shape to increase its strength and to create a cavity between the rear side of the window and the front side of the display screen.

7. A display assembly according to claim 4, wherein a dust seal is provided between the protection window and the display unit along the periphery of the display screen.

8. A display assembly according to claim 7, wherein the dust seal is provided by punched plastics foam coated with an adhesive.

9. A display assembly according to claim 4, wherein the coupling means are provided on the plate-shaped, light-guiding member and the protection window as a number of plastics lugs and tabs for mutual engagement.

10. A display assembly according to claim 9, wherein the plate-shaped, light-guided member is provided with gripping walls extending substantially perpendicularly to the plane of the display screen along two opposite sides thereof, and the gripping walls are provided with recesses for receiving corresponding tabs of the protection window.

11. A display assembly according to claim 10, wherein the gripping walls on the plate-shaped, light-guiding member and the tabs on the protection window establish a snap connection when assembling the assembly with the display unit sandwiched therebetween.

12. A display assembly according to claim 10, wherein the gripping walls extend on both sides of the plate-shaped, light-guiding member, whereby the snap connection may be temporarily locked by preventing movement of the griping wall parts facing away from the protection window.

13. A display assembly according to claim 4, wherein the rear side of the plate-shaped, light-guiding member is provided with a reflecting layer which prevents light from escaping via the rear side of the assembly.

14. A display assembly according to claim 5, wherein the printed circuit board carrying the light emitting diodes is provided along one side of the display screen on the display unit, and said printed circuit board also carries the display driver and a multi-pin connector part for establishing electrical connections with a communication unit in which the assembly is used.

15. A display assembly according to claim 14, wherein the plate-shaped, light-guiding member is extended with a carrier part supporting said display driver carrying the printed circuit board, and provided with aligning means and fastening means for aligning and fastening the assembly in relation to the communication unit in which the assembly is used.
